(19) United States
(12) Patent Application Publication
(10) Pub. No.: US 2020/0202425 A1
(43) Pub. Date: Jun. 25, 2020

(54) COMPUTER-PROJECTED RISK ASSESSMENT USING VOLUNTARILY CONTRIBUTED INFORMATION

(71) Applicant: FAIR ISAAC CORPORATION, Roseville, MN (US)

(72) Inventors: Sally Ritsuko Taylor-Shoff, San Rafael, CA (US); Ethan J. Dornhelm, San Rafael, CA (US); Erik Franco, Napa, CA (US); David Shellenberger, Corte Madera, CA (US); Can Arkali, San Francisco, CA (US); Radha Chandra, Berkeley, CA (US)

(21) Appl. No.: 16/225,589

(22) Filed: Dec. 19, 2018

(51) Int. Cl. G06Q 40/02; G06Q 20/40

(52) U.S. Cl. CPC G06Q 40/025; G06Q 20/40

(57) ABSTRACT

A computer-implemented method for risk assessment and providing refinements to credit risk analysis based on a variety of information, including information voluntarily contributed by an applicant. The method may comprise performing a risk analysis based on a first set of information available in at least a first credit information data source and receiving a second set of information, in response to determining that the analysis provides a first result that is unfavorable to the applicant. The second set of information may be unavailable in the at least first credit information data source, and the second set of information may be retrievable from at least a secondary data source after the applicant's informed interaction with a computer-implemented interface configured to verify an authenticated approval by the applicant to provide access to information associated with at least one of the applicant's financial accounts.

### COPYRIGHT & TRADEMARK NOTICES

A portion of the disclosure of this patent document may contain material, which is subject to copyright protection. The owner has no objection to facsimile reproduction by any one of the patent document or the patent disclosure, as it appears in the Patent and Trademark Office patent file or records, but reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter generally relates to improvements in a computing technology associated with risk assessment and, more particularly, to computing systems and methods that may provide refinements to credit risk analysis based on a variety of information, including information voluntarily contributed by an applicant.

### BACKGROUND

Traditional credit scores are based on analysis of data gathered by a credit reporting agency. Typically, the agency collects or has access to data related to an applicant's credit history, including number of accounts, line of credit available on each account, and past history delinquencies. Collecting this information, generally, does not require the applicant's consent.

Because often the amount and type of data considered plays a significant role in calculating an applicant's final credit score, solely relying on information ordinarily collected by credit reporting agencies may not be as conducive to determining an applicant's ultimate creditworthiness. As such, traditional risk assessment strategies sometimes fail to account for certain information that can help significantly improve an applicant's credit score.

Technological improvements over the state of the art systems are needed that can allow for a more refined risk assessment strategy, according to which an applicant's chances for approval or qualification may be enhanced, by taking into account additional financial information and risk factors in the proper context.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with some implementations of the disclosed subject matter, a computer-implemented method for risk assessment and providing refinements to credit risk analysis based on a variety of information, including information voluntarily contributed by an applicant, is provided. The method may comprise performing a risk analysis based on a first set of information available in at least a first credit information data source and receiving a second set of information, in response to determining that the analysis provides a first result that is unfavorable to the applicant. The second set of information may be received, in response to the applicant being requested to voluntarily authorize access to the second set of information.

The second set of information may be unavailable in the at least first credit information data source, and the second set of information may be retrievable from at least a secondary data source after the applicant's informed interaction with a computer-implemented interface configured to verify an authenticated approval by the applicant to provide access to information associated with at least one of the applicant's financial accounts as available from the at least secondary data source. Additional risk analysis may be performed for the applicant based on the second set of information to determine whether the second set of information enhances the applicant's potential for a second result that is more favorable than the first result.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1 illustrates an example operating environment, in accordance with one or more embodiments, wherein primary and secondary financial data about an applicant may be utilized to perform a multi-level risk assessment.

FIGS. 2A through 2D provide example illustrations of an interface that allows a user to voluntarily provide access to certain user information, in accordance with one embodiment.

FIG. 3A is an example flow diagram of a method of determining whether an applicant's credit risk score may be enhanced, in accordance with one or more implementations.

FIG. 3B illustrates example results generated from analyzing an applicant's financial data, where the result on the right reflects an enhanced risk score.

FIG. 4 is an illustration of an example set of data that may be used to determine or enhance an applicant's creditworthiness, where such data is ordinarily not available to a credit reporting agency without the applicant's consent, in accordance with one or more embodiments.

FIGS. 5A through 5D are example graphs that illustrate the relationship between likelihood of repayment and different types of data and factors that may be taken into account to help enhance an applicant's credit score.

FIG. 6 is a block diagram of a computing system 1000 that may be utilized to perform one or more computer processes disclosed herein as consistent with one or more embodiments.

Where practical, the same or similar reference numbers denote the same or similar or equivalent structures, features, aspects, or elements, in accordance with one or more embodiments.

### DETAILED DESCRIPTION OF EXAMPLE IMPLEMENTATIONS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

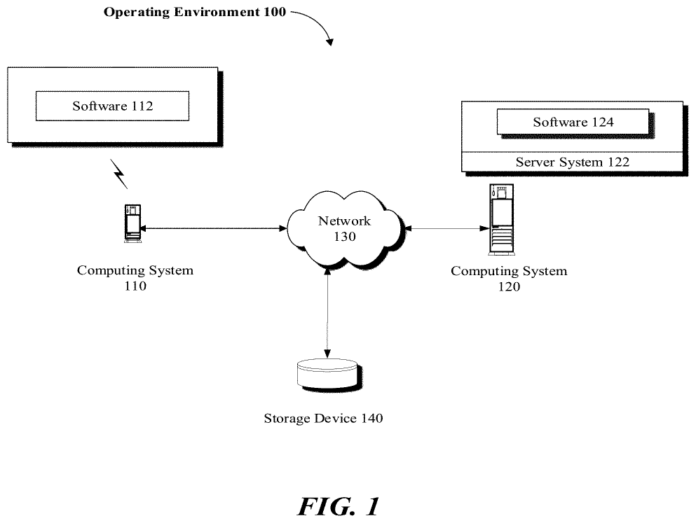

Referring to FIG. 1, an example operating environment 100 is illustrated in which a computing system 110 may be used by a user to interact with software 112 being executed on computing system 110. The computing system 110 may be a general computer, a handheld mobile device (e.g., a smart phone), a tablet, or other communication capable computing device. Software 112 may be a web browser, a dedicated app or other type of software application running either fully or partially on computing system 110.

Computing system 110 may communicate over a network 130 to access data stored on storage device 140 or to access services provided by a computing system 120. Depending on implementation, storage device 140 may be local to, remote to, or embedded in one or more of computing systems 110 or 120. A server system 122 may be configured on computing system 120 to service one or more requests submitted by computing system 110 or software 112 (e.g., client systems) via network 130. Network 130 may be implemented over a local or wide area network (e.g., the Internet).

Computing system 120 and server system 122 may be implemented over a centralized or distributed (e.g., cloud-based) computing environment as dedicated resources or may be configured as virtual machines that define shared processing and storage resources. Execution, implementation or instantiation of software 124 over server system 122 may also define a special purpose machine that provides remotely situated client systems, such as computing system 110 or software 112, with access to a variety of data and services as provided below.

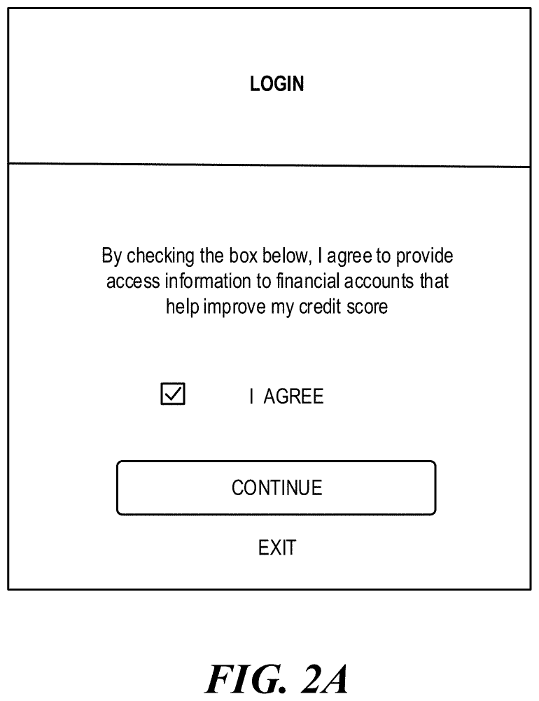

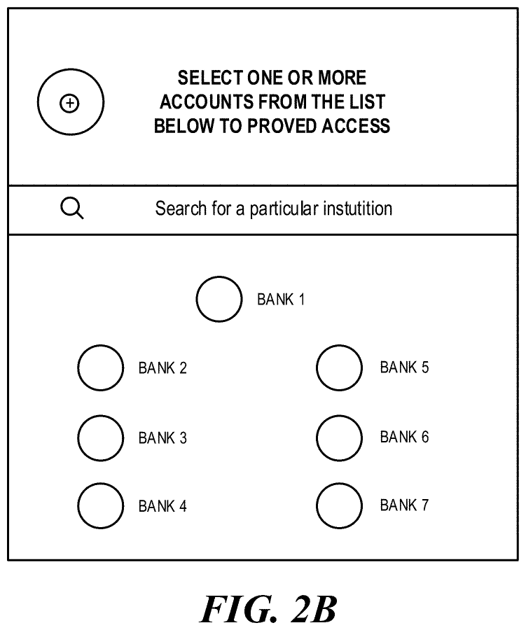

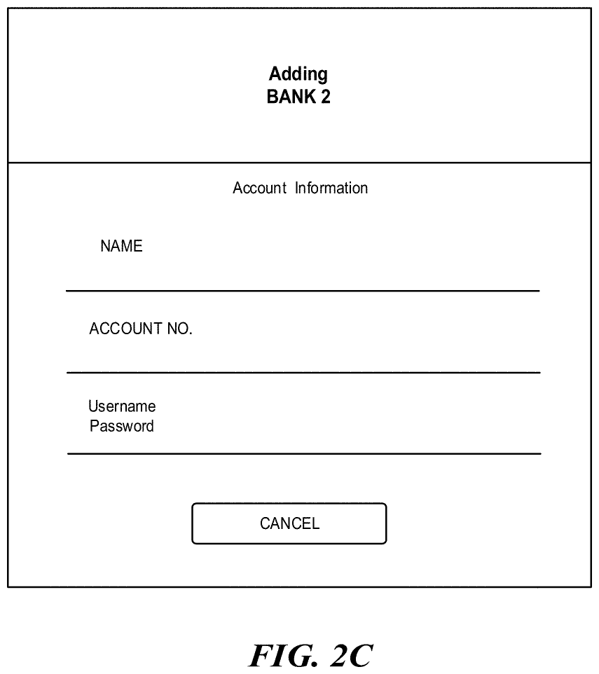

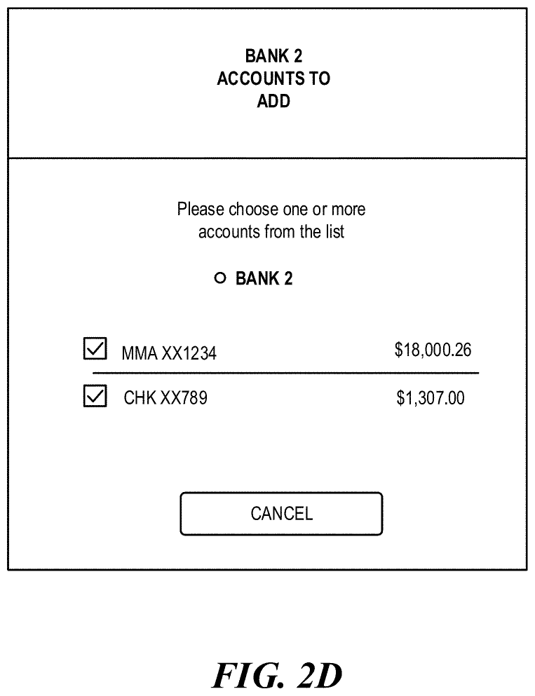

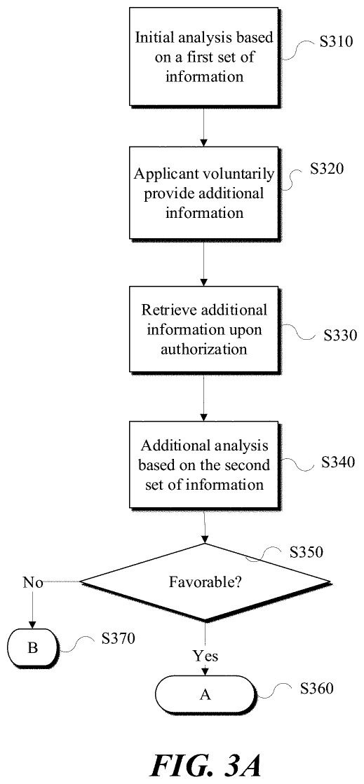

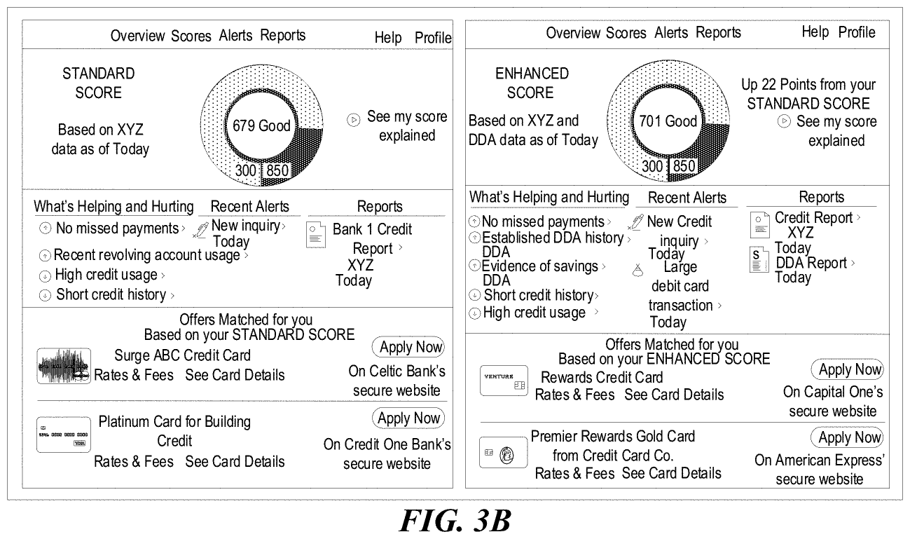

In accordance with one or more implementations, the provided services by the special purpose machine or software 124 may include one or more of: providing a user with access to a portal to authorize access to the user's financial information (e.g., FIGS. 2A-2D), or providing multi-level credit risk analysis (e.g., FIGS. 3A-3B). For example, as shown in FIGS. 2A through 2D, a user interacting with a graphical user interface rendered on computing system 110 may launch an application or software 112. Software 112 may be a browser or app that provides the user with the ability to authorize access to one or more of the user's financial account data.

Referring to FIG. 2A, a user may choose to provide an acknowledgment (e.g., by marking a checkbox) that the user understands certain terms of an agreement that would allow a third party (e.g., a consumer reporting agency or other entity) access to the user's bank account data, for the purpose of improving the user's credit score. Thereafter, the user's acknowledgment may be transmitted to computing system 120 and processed by software 124. Upon successful processing, a graphical interface such as that shown in FIG. 2B may be presented to the user on computing system 110 by software 112.

Referring with FIG. 2B, the user may be provided with a number of options to select from certain financial institutions. The user may select one or more institutions from the example interface, depending on whether the user has a financial relationship with one or more of the institutions displayed. Once the user has made a selection, an authentication mechanism, such as a login interface shown by way of example in FIG. 2C may be presented to the user on computing system 110.

Referring to FIG. 2C, an example login interface may include several input fields (e.g., username, password, pin, etc.) which may prompt the user to enter relevant information for the purpose of authenticating the user. Upon entry of the authentication information, software 112 may collect and transmit the provided information over network 130 to computing system 120, as received by software 124. Software 124 upon processing the authentication information, either grants or denies access to the user's selected financial account. If the authentication information is successfully verified, then a user interface such as that illustrated in FIG. 2D may be rendered on computing system 110.

Referring to FIG. 2D, one or more accounts may be displayed to the user, depending on the number of accounts the user may have at the selected institution. FIG. 2D illustrates that the user in this example scenario has two accounts with Chase, a checking account and a savings account. If the user wishes to provide access to information from one or more of the displayed accounts, the user may interact with the graphical user interface (e.g., by marking a checkbox associated with the account to be selected). Depending on implementation, the user may have the option of choosing from one or more accounts, or completely cancel the transaction, if so desired.

Accordingly, user's voluntary interaction with a portal, such as the example graphical user interface disclosed above, may allow a user to authorize access to the user account information in a secure environment. Computing system 120 and software 124 may be central or distributed resources or components of a server system 122 utilized by a consumer reporting agency or an independent third party entity. Server system 122 in combination with software 124 may have the resources and be configured to process and verify the authenticity of user requests for providing financial account data to a credit reporting agency or an independent third party entity that may communicate the financial account data to a credit reporting agency, depending on implementation.

Referring to FIG. 3A, in accordance with example embodiments, a computer-implemented method may be provided to perform risk analysis for an applicant based on a first set of information available in at least a first credit information data source, during a first analysis phase (S310). As provided in further detail below, the first set of information may include information collected by, for example, a credit reporting agency without the user's active involvement. If it is determined that the analysis result is unfavorable to the applicant, the applicant may be invited to voluntarily provide a second set of information (S320).

The applicant may provide the second set of information, for example, by way of interacting with an interface such as that provided above (see FIGS. 2A-2D). It is noteworthy that the particular visual designs in the graphical user interfaces illustrated in FIGS. 2A through 2D are provided by way of non-limiting example, and other graphical implementations may be possible in other variations. As to the second set of information voluntarily provided by an applicant, such information may include data that is ordinarily or traditionally not collected, or cannot be collected, by a credit reporting agency, or a third party data collection entity without an applicant's active participation.

Referring back to FIG. 3A, in some variations, the second set of information may be retrievable from at least a secondary data source (e.g., directly from institutions with which the applicant has a financial or banking relationship). This second set of information may be obtained, for example, either by the credit reporting agency, or an independent third party entity, after obtaining the applicant's informed consent (S330). As provided earlier, the applicant's express authorization for access to the applicant's financial account data may be obtain in a secure environment based on the applicant's interaction with a computer-implemented interface configured to verify an authenticated approval by the applicant for access to information associated with at least one of the applicant's financial accounts.

In one implementation, in response to successful authentication of the applicant, the second set of information may be collected from one or more applicant-selected accounts in one or more applicant-selected financial institutions. An additional risk analysis may be performed based on the second set of information, for example, during a second phase (S340). Based on the additional risk analysis, it may be determined whether the second set of information enhances the applicant's potential for a second result that is more favorable than the first result obtained from the risk analysis performed during the first phase (S350). If the result of the risk analysis is more favorable, the user may now be eligible for approval or for better credit options from the financial institution (S360). Otherwise, the user may be deemed no more credit worthy than in the first phase of the risk analysis, and therefore may not be eligible for approval or for better credit options from the financial institution (S370).

Referring to FIG. 3B, example results generated from analyzing an applicant's financial data are illustrated. As shown, the result on the left reflects an original or standard score (e.g., 679) for an applicant calculated during a first analysis phase, without taking into account additional financial information to which the applicant has voluntarily provided access. The result on the right, in FIG. 3B, reflects an enhanced score (e.g., 701) for the same applicant, after considering the additional financial data during a second phase of the analysis. Accordingly, in certain implementations, an improvement in the candidate's credit score may make the candidate eligible for approval or for better credit options. As shown, for example, an enhanced score may provide the applicant with the opportunity to apply for a higher-limit credit card.

In example embodiments, the enhanced credit score may be utilized before or after the submission of a credit application, for example, for the purpose of account management or lead generation (e.g., see the bottom of FIG. 3B showing promotional offers). As such, depending on the nature and type of additional financial data voluntarily contributed by an applicant (e.g., at the time of application), applicant's informed consent at the time may be relied upon to allow a financial institution or a third party continued access financial data shared by the applicant, even after the applicant has been approved for the credit account. In example embodiments, refreshed or updated enhanced credit score may be calculated and generated on an ongoing basis, or at least periodically to support account management activities such as credit line increase or decrease, line closure, promotions, etc.

It is also noteworthy that in some scenarios, the calculated enhanced score (e.g., 701) does not replace the original credit score (e.g., 679). That is, an applicant's enhanced score may have a shorter life-span or be utilized temporarily for a period in time when an applicant is applying for credit and desires to provide additional information to enhance the calculated original credit score. Depending on implementation, the enhanced credit score may be useful for a particular session, a defined period of time, or during a particular application process. Thus, if the applicant applies for a different loan or credit or start a different application process, the enhanced score generated for a prior application process may be no longer available. As such, a new enhanced score may be calculated for which the applicant may have to provide additional express approval.

Accordingly, an applicant's express approval for a credit reporting agency, or an independent third party, to access the second set of information, which includes data beyond what is ordinarily available to a credit reporting agency, may help refine an applicant's financial risk analysis. The independent third party may be an entity other than the credit reporting agency with established relationships and secure systems that acts as a proxy between the credit reporting agency and the financial institutions. For instance, if an applicant has failed an initial approval phase, a credit reporting agency, through the independent third party entity, may upon express consent by the applicant receive data about, for example, the applicant's banking transactions, such as cash flow or balance information over a certain period of time, date of earliest transactions, account inception dates, overdraft events and other credit or risk-related data available to initiate a second approval phase.

In other words, depending on implementation, in addition to using traditional credit scores or conventional risk rating criteria, new or secondary data such as information about an applicant's direct relationship with a bank, or other financial or asset-related institutions, may be accessed, optionally in real-time, by either the credit reporting agency or an independent third party entity that acts as a proxy. The collected secondary data may then be used to help refine the assessment of an applicant's creditworthiness. Such refined assessment may result in an improved credit score, thus making the applicant a better candidate for obtaining a loan or a higher line of credit.

Conversely, the additional secondary information may also result in a downgrade in an applicant's credit rating, if the additional information includes indications that are adverse to an applicant's credit profile. In an example implementation, during a first approval phase, an applicant may apply for a loan or a line of credit from a bank. After an initial analysis, the bank may determine that the applicant does not meet the threshold requirements for obtaining a loan because, among other things, the applicant lacks sufficient information in the traditional credit file to derive a robust and accurate assessment of creditworthiness. Incorporation of additional data such as bank account information may be conducive to a more refined credit assessment for such applicant and possibly enhance the chances for approval.

In certain scenarios, the applicant's credit rating may be too low or the credit file may be too sparse to warrant the initiation of a second approval phase, during which applicant's secondary financial data may be analyzed. However, if the analysis of applicant's financial data during the first approval phase, indicates that the applicant is a borderline risk candidate or for other reasons should be given additional consideration, the applicant may be provided with an opportunity to increase his chances of qualification via a second approval phase.

Accordingly, as provided earlier, the applicant may be requested to authorize a credit reporting agency or other entity to access the applicant's secondary financial data (e.g., banking records and history). The request for authorization may be provided to the applicant directly by a bank, by a credit reporting agency, or through one or more third party entities that may be capable of providing an interface to the applicant (e.g., for the purpose of safely and securely obtaining the applicant's secondary financial data). In some example implementations, the interface may be provided via a web-portal or a software-implemented application programing interface (API) available through a provider of financial data management solutions as provided herein above.

In accordance with one or more variations or implementations, a personal interface such as that illustrated in FIGS. 2A through 2D may be generated through which the applicant may login to a secure portal. The portal may provide the applicant with one or more options to select certain financial accounts (e.g., bank account, stock brokerage account, etc.). The selected financial accounts may include information beyond that which has been already considered in the first approval phase. In example embodiments, when an account is added, additional authorization requests may be generated for the added account. For example, an applicant may be prompted, in real time, to provide the applicant's login and password information for directly logging into the added account. Once the requisite authorization is provided via proper authentication means, applicant's added accounts are linked and secondary financial data available through the linking of the accounts may be accessible for the purpose of credit risk analysis.

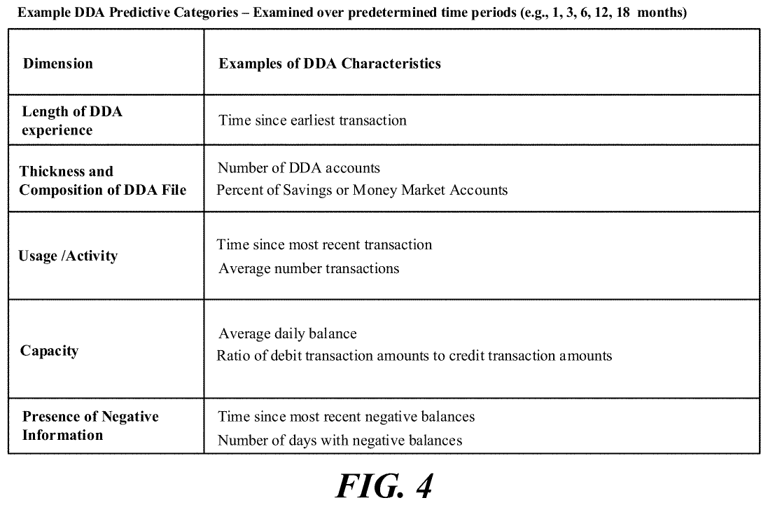

Accordingly, the secondary financial data may be analyzed during the second approval phase to determine if a target candidate may be approved. The analysis may take into account a variety of factors directly made available by the applicant, by way of personally and voluntarily linking selected financial accounts. The analysis in the second phase may thus indicate the applicant's additional financial weaknesses or strengths. Without limiting the scope of the disclosed subject matter, some of these factors are illustrated in FIG. 4, by way of example. For instance, in some embodiments, any secondary data in addition to those traditionally considered by a consumer reporting agency may be utilized to help determine the creditworthiness of an applicant that may have failed an initial phase of the credit approval process.

Referring to FIG. 4, secondary financial data may include, without limitation, length of the applicant's banking relationship. For example, the date of inception of one or more accounts or the date of the earliest transactions in the accounts may be considered. A longer relationship may be deemed to suggest the applicant is a better credit risk, for example. Further, the number of financial accounts (e.g., demand deposit accounts) and the types of such accounts (e.g., checking, savings, CD, etc.) may be considered as a factor. For example, an applicant with a higher number of accounts and having both savings and checking accounts may be considered as a better credit risk.

Other examples of secondary financial data that may be considered in a secondary approval phase may include the level of usage or activity in one or more accounts, the daily balances or average balances over certain time periods, the frequency, number or dollar amounts associated with overdraft or insufficient fund events, or the number of such events during a certain period. It is noteworthy that the specific examples included herein should not be construed as limiting the scope of the secondary information only to those financial information that may be obtained from analyzing an applicant's relationship with deposit holding banks.

Examples of other secondary information include, without limitation, data that may be available from financial brokerage firms (e.g., equity holdings in financial markets in the form of stocks, bonds, and the like), financial data related to ownership of electronic, digital or crypto currencies (e.g., bit-coins), financial data related to ownership of real estate, tax data, payment information not typically found in a traditional credit report (e.g. rent, utility, telephone, cable, etc.) or any other data that may provide an understanding of the applicant's net worth, cash flows, spending habits, liabilities, or risk profile.

As provided earlier, based on the secondary applicant data provided during a second approval phase, creditworthiness of the applicant may be further analyzed toward a favorable or unfavorable conclusion. For example, if the additional analysis reflects the applicant is a better credit risk, then an improved credit score may be associated with the applicant increasing the applicant's chances for approval. In contrast, if the secondary analysis reflects the applicant is not a safe credit risk, assessment of the applicant's creditworthiness may remain the same or may be downgraded, thereby not helping the applicant's chances for approval. Certain risk factors may be given higher or lower weights in determining an applicant's creditworthiness.

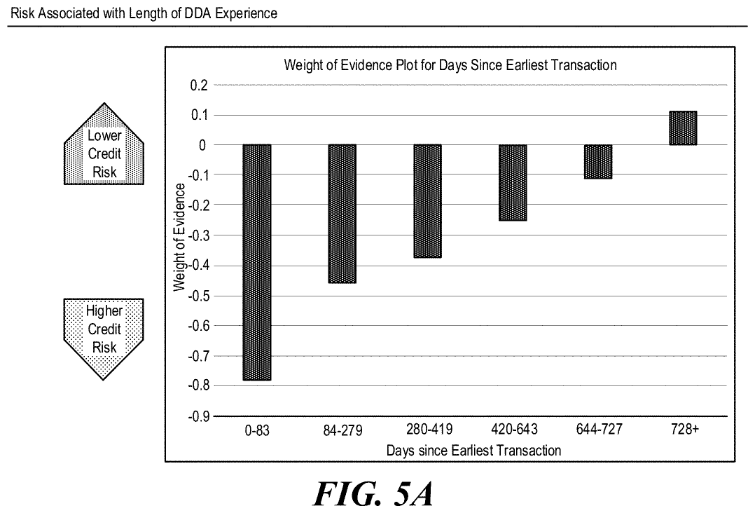

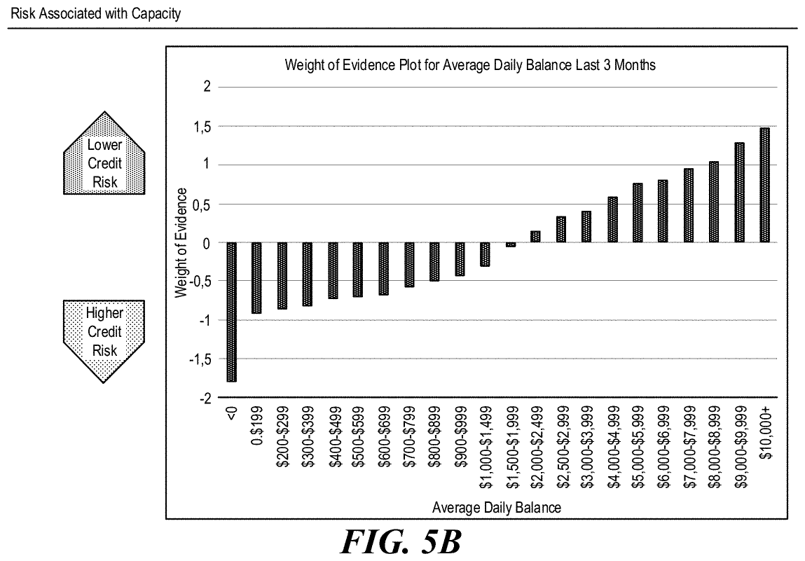

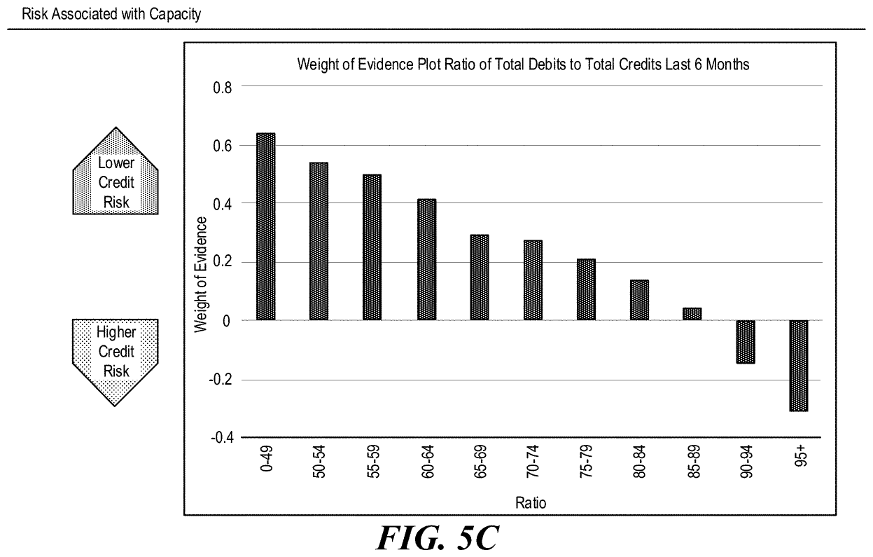

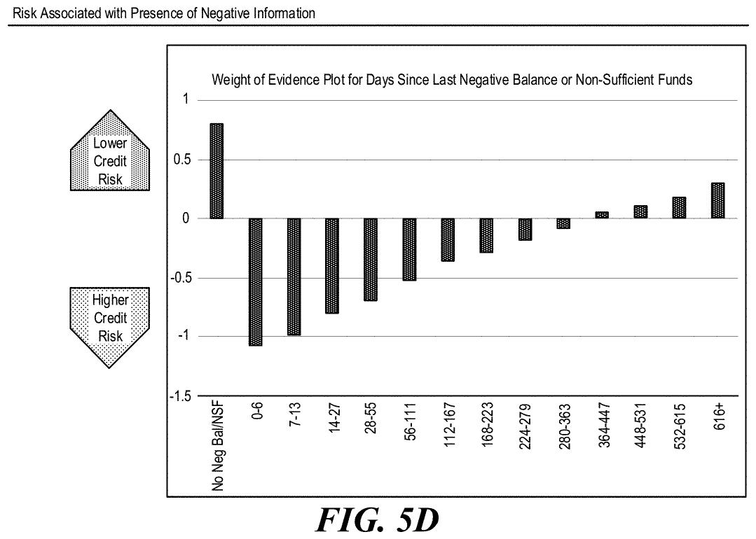

Referring to FIGS. 5A through 5D, factors including length of time an applicant has had a relationship with a bank (e.g., length of demand deposit accounts (DDA) experience) may be taken into consideration (FIG. 5A). Other factors may include, average daily balance (FIG. 5B), ratio of total debits to total credits (FIG. 5C), or number or recency of overdrafts or NSF (not sufficient funds) transactions over a course of time (FIG. 5D). As another example, voluntarily provided financial information that reflect an applicant's average balance in one or more accounts may be given a higher weight over information that reflect the number of overdraft events for an applicant depending on, for example, empirical assessment of these factors' relationship to prediction of credit risk.

Accordingly, the programming of a risk analysis model may be adjusted, for example, based on a comparative history of applicants falling in certain categories or satisfying certain conditions or constraints. For example, analysis of historic applicant data may show some applicants initially thought to be good risks who did not perform as expected (e.g., the candidates were approved for credit, but failed to timely repay their loans) or vice versa. In certain embodiments, a model may be defined or implemented using constraint satisfaction problem (CSP) methodology, in which particular or random criteria are defined as a set of objects whose state must satisfy a number of constraints or limitations in order for the problem to be solved (i.e., determine whether a candidate may be approved).

Accordingly, an improved risk analysis computing system is provided that enhances the capabilities of a computerized risk assessment system by allowing a credit applicant to be more thoroughly considered via the incorporation of additional data. These disclosed improvements lead to advancement in risk analysis computing technology with advantages that may include a more accurate and robust credit rating system, for example. In one aspect, a mathematical model may be trained and developed to generate risk scores based on the model's utilization of a large base of primary data (i.e., first set of information) and secondary data (i.e., second set of information) available for a plurality of applicants coupled with information about how the individuals in this data samples subsequently performed on their credit obligations.

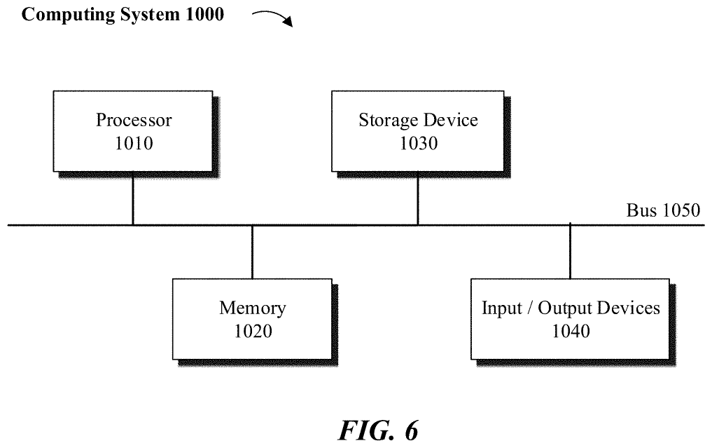

As shown in FIG. 6, the computing system 1000 can include a processor 1010, a memory 1020, a storage device 1030, and input/output devices 1040. The processor 1010, the memory 1020, the storage device 1030, and the input/output devices 1040 can be interconnected via a system bus 1050. The processor 1010 is capable of processing instructions for execution within the computing system 1000. Such executed instructions can implement one or more components of, for example, a cloud platform. In some implementations of the current subject matter, the processor 1010 can be a single-threaded processor. Alternately, the processor 1010 can be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 can store data structures representing configuration object databases, for example. The storage device 1030 is capable of providing persistent storage for the computing system 1000. The storage device 1030 can be a floppy disk device, a hard disk device, an optical disk device, or a tape device, or other suitable persistent storage means. The input/output device 1040 provides input/output operations for the computing system 1000. In some implementations of the current subject matter, the input/output device 1040 includes a keyboard and/or pointing device. In various implementations, the input/output device 1040 includes a display unit for displaying graphical user interfaces.

According to some implementations of the current subject matter, the input/output device 1040 can provide input/output operations for a network device. For example, the input/output device 1040 can include Ethernet ports or other networking ports to communicate with one or more wired and/or wireless networks (e.g., a local area network (LAN), a wide area network (WAN), the Internet).

In some implementations of the current subject matter, the computing system 1000 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1040. The user interface can be generated and presented to a user by the computing system 1000 (e.g., on a computer screen monitor, etc.).

One or more aspects or features of the subject matter disclosed or claimed herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that may be executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server may be remote from each other and may interact through a communication network. The relationship of client and server arises by virtue of computer programs running on the respective computers and having a client-server relationship to each other.

These computer programs, which may also be referred to as programs, software, software applications, applications, components, or code, may include machine instructions for a programmable controller, processor, microprocessor or other computing or computerized architecture, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

What is claimed is:

1. A computer-implemented method comprising:
performing a risk analysis for an applicant based on a first set of information available in at least a first credit information data source;
receiving a second set of information, in response to determining that the analysis provides a first result that is unfavorable to the applicant,
the second set of information being unavailable in the at least first credit information data source, and
the second set of information being retrievable from at least a secondary data source after the applicant's informed interaction with a computer-implemented interface; and
performing additional risk analysis for the applicant based on the second set of information to determine whether the second set of information enhances the applicant's potential for a second result that is more favorable than the first result.

2. The method of claim 1, wherein the second set of information is received in association with the applicant voluntarily authorizing access to the second set of information, in response to receiving a request, and wherein the second result is generated, in response to determining the second set of information includes additional favorable data about the applicant's creditworthiness.

3. The method of claim 1, wherein the second result is generated, in response to determining the second set of information includes additional data about at least one reason the first result was unfavorable, and wherein the computer-implemented interface is configured to verify an authenticated approval by the applicant to provide access to information associated with at least one of the applicant's financial accounts as available from the at least secondary data source.

4. The method of claim 1, wherein the first set of information includes financial data collected by a credit reporting agency about the applicant, without the applicant's express authorization.

5. The method of claim 1, wherein the second set of information includes financial data provided to at least a credit reporting agency or an entity independent of the credit reporting agency, with the applicant's express authorization.

6. The method of claim 1, wherein the first set of information comprises the applicant's credit history, including at least one or more of: number of accounts, line of credit available on at least one of the accounts, or past history of at least one of the accounts' delinquencies.

7. The method of claim 1, wherein the second set of information comprises the applicant's direct deposit account (DDA) banking history.

8. The method of claim 7, wherein the direct deposit account (DDA) banking history provides information about at least one or more of: level of usage or activity in the applicant's one or more bank accounts, daily balances or average balances over certain time periods, frequency, number or dollar amounts associated with overdraft or insufficient fund events, or number of financial transactions or events during a defined time period for the applicant's one or more bank accounts.

9. The method of claim 1, wherein the second set of information comprises at least one or more of: financial data available from financial brokerage firms servicing the applicant's brokerage needs, or financial data related to ownership of at least one of real estate assets, personal assets, or electronic, digital or crypto currencies.

10. The method of claim 9, wherein the second set of information further comprises data associated with least one or more of: the applicant's equity holdings in financial markets in the form of stocks or bonds, or data associated with the applicant's income or the applicant's tax liabilities.

11. A system comprising:
at least one programmable processor; and
a non-transitory machine-readable medium storing instructions that, when executed by the at least one programmable processor, cause the at least one programmable processor to perform operations comprising:
performing a risk analysis for an applicant based on a first set of information available in at least a first credit information data source;
receiving a second set of information, in response to determining that the analysis provides a first result that is unfavorable to the applicant,
the second set of information being unavailable in the at least first credit information data source, and
the second set of information being retrievable from at least a secondary data source after the applicant's informed interaction with a computer-implemented interface; and
performing additional risk analysis for the applicant based on the second set of information to determine whether the second set of information enhances the applicant's potential for a second result that is more favorable than the first result.

12. The system of claim 11, wherein the second set of information is received in association with the applicant voluntarily authorizing access to the second set of information, in response to receiving a request, and wherein the second result being generated, in response to determining the second set of information includes additional favorable data about the applicant's creditworthiness.

13. The system of claim 11, wherein the second result is generated, in response to determining the second set of information includes additional data about at least one reason the first result was unfavorable, and wherein the computer-implemented interface is configured to verify an authenticated approval by the applicant to provide access to information associated with at least one of the applicant's financial accounts as available from the at least secondary data source.

14. The system of claim 11, wherein the first set of information includes financial data collected by a credit reporting agency about the applicant, without the applicant's express authorization.

15. The system of claim 11, wherein the second set of information includes financial data provided to at least a credit reporting agency or an entity independent of the credit reporting agency, with the applicant's express authorization.

16. A computer program product comprising a non-transitory machine-readable medium storing instructions that, when executed by at least one programmable processor, cause the at least one programmable processor to perform operations comprising:
performing a risk analysis for an applicant based on a first set of information available in at least a first credit information data source;
receiving a second set of information, in response to determining that the analysis provides a first result that is unfavorable to the applicant,
the second set of information being unavailable in the at least first credit information data source, and
the second set of information being retrievable from at least a secondary data source after the applicant's informed interaction with a computer-implemented interface; and
performing additional risk analysis for the applicant based on the second set of information to determine whether the second set of information enhances the applicant's potential for a second result that is more favorable than the first result.

17. The computer program product of claim 16, wherein the second set of information is received in association with the applicant voluntarily authorizing access to the second set of information, in response to receiving a request, the second result being generated, in response to determining the second set of information includes additional favorable data about the applicant's creditworthiness.

18. The computer program product of claim 16, wherein the second result is generated, in response to determining the second set of information includes additional data about at least one reason the first result was unfavorable, and wherein the computer-implemented interface is configured to verify an authenticated approval by the applicant to provide access to information associated with at least one of the applicant's financial accounts as available from the at least secondary data source.

19. The computer program product of claim 16, wherein the first set of information includes financial data collected by a credit reporting agency about the applicant, without the applicant's express authorization.

20. The computer program product of claim 16, wherein the second set of information includes financial data provided to at least a credit reporting agency or an entity independent of the credit reporting agency, with the applicant's express authorization.
